(19) United States
(12) Patent Application Publication
(10) Pub. No.: US 2026/0258865 A1
(43) Pub. Date: Sep. 3, 2026

(54) SEALING MATERIAL AND SEALING STRUCTURE

(71) Applicant: DAIKIN FINETECH, LTD., Yamatokoriyama-shi, Nara (JP)

(72) Inventors: Masashi SUZUKI, Yamatokoriyama-shi, Nara (JP); Masaya OKUDA, Yamatokoriyama-shi, Nara (JP); Akito UCHIDA, Yamatokoriyama-shi, Nara (JP)

(21) Appl. No.: 18/994,455

(22) PCT Filed: Jul. 6, 2023
(86) PCT No.: PCT/JP2023/025123

§ 371 Date: Jan. 14, 2025

(30) Foreign Application Priority Data
Jul. 22, 2022 (JP) 2022-116947

(51) Int. Cl. F16J 15/02

(52) U.S. Cl. CPC F16J 15/024

(57) ABSTRACT

The sealing material and the sealing structure are configured to maintain airtightness while reducing the reaction force in attachment. The sealing material includes a first curved surface that is located on a first side in a first direction and concave toward a second side opposite from the first side, and a second curved surface located on the second side in the first direction and convex toward the second side. The second curved surface overlaps with the entirety of the first curved surface as viewed in the first direction. The sealing structure includes the sealing material and seal objects sandwiching the sealing material from both sides in a second direction orthogonal to the first direction.

### TECHNICAL FIELD

The present invention relates to a sealing material and a sealing structure.

### BACKGROUND ART

Sealing materials are widely used for purposes such as imparting airtightness to an object to be sealed. Patent Document 1 discloses an example of a conventional sealing material. The sealing material disclosed in the document has a cross-sectional shape having a bottom, a first side wall, a second side wall, and a recess. This sealing material is configured to be attached to an object to be sealed in such a manner that the bottom, the first side wall, and the second side wall are held in contact with the recess formed in the object.

### PRIOR ART DOCUMENT

### Patent Document

Patent Document 1: JP-A-2018-40472

### SUMMARY OF THE INVENTION

### Problem to be Solved by the Invention

Sealing materials are attached to various types of objects, and therefore, need to have appropriate properties depending on these objects. A larger deformation of a sealing material to impart airtightness results in the sealing material exerting larger reaction force on the object to be sealed. When the object to be sealed is made of a brittle material, such as quartz, excessively large reaction force may break the object. When two members that slide against each other are to be sealed, the sealing material partially wears down easily if reaction force is excessively large. Wear particles of the sealing material may affect the seal object as impurities.

The present invention has been conceived in light of the above-described circumstances, and an object of the present invention is to provide a sealing material and a sealing structure that are capable of maintaining airtightness while reducing the reaction force in attachment.

### Means to Solve the Problem

A sealing material provided according to a first aspect of the present invention includes a first curved surface that is located on a first side in a first direction and concave toward a second side opposite from the first side, and a second curved surface located on the second side in the first direction and convex toward the second side. The second curved surface overlaps with the entirety of the first curved surface as viewed in the first direction.

In a preferred embodiment of the present invention, the first curved surface includes a first end point that is the end on a first side in a second direction orthogonal to the first direction and a second end point that is the end on a second side opposite from the first side in the second direction. Both a first straight line that is an extension of a normal to the first curved surface at the first end point and a second straight line that is an extension of a normal to the first curved surface at the second end point intersect the second curved surface.

In a preferred embodiment of the present invention, the first curved surface and the second curved surface are each axisymmetric with respect to the same symmetry axis extending in the first direction.

In a preferred embodiment of the present invention, the thickness of a portion along the symmetry axis is equal to or greater than 0.5 times and equal to or less than 3.0 times the thickness of a portion along the first straight line or the second straight line.

In a preferred embodiment of the present invention, the angle formed between the first straight line and the second straight line is equal to or greater than 60° and equal to or less than 210°.

In a preferred embodiment of the present invention, the sealing material further includes a third curved surface interposed between the first curved surface and the second curved surface on the first side in a second direction orthogonal to the first direction, and a fourth curved surface interposed between the first curved surface and the second curved surface on the second side in the second direction.

In a preferred embodiment of the present invention, the sealing material has the shape of a closed ring.

In a preferred embodiment of the present invention, the first side in the first direction is the outer side of the ring shape, and the second side in the first direction is the inner side of the ring shape.

A sealing structure provided according to a second aspect of the present invention includes the sealing material provided according to the first aspect of the present invention, and a seal object sandwiching the sealing material from both sides in a second direction orthogonal to the first direction.

### Advantages of the Invention

The present invention allows maintaining airtightness while reducing the reaction force in attachment.

Other features and advantages of the present invention will become apparent from the detailed description given below with reference to the accompanying drawings.

### BRIEF DESCRIPTION OF THE DRAWINGS

FIG. 1 shows a sealing material according to a first embodiment of the present invention, where (a) is a plan view, (b) is a front view, and (C) is a sectional view taken along line c-c in (a).

FIG. 2 is a partial enlarged sectional view showing the sealing material according to a first embodiment of the present invention.

FIG. 3 shows a sealing structure according to the first embodiment of the present invention, where (a) is a partial enlarged sectional view before airtightness is achieved, and (b) is partial enlarged sectional view after airtightness is achieved.

FIG. 4(a) and FIG. 4(b) are partial enlarged sectional views showing a first variation and a second variation, respectively, of the sealing material according to the first embodiment of the present invention.

FIG. 5(a) is a plan view showing a sealing material according to a second embodiment of the present invention, and FIG. 5(b) is a partial plan view showing a sealing material according to a third embodiment of the present invention.

FIG. 6(a) and FIG. 6(b) are partial enlarged sectional views showing a sealing material according to a fourth embodiment of the present invention and its first variation, respectively.

FIG. 7(a) and FIG. 7(b) are partial enlarged sectional views showing a second variation and a third variation, respectively, of the sealing material according to the fourth embodiment of the present invention.

FIG. 8 is a partial enlarged view showing a sealing material according to a fifth embodiment of the present invention.

### MODE FOR CARRYING OUT THE INVENTION

The following describes preferred embodiments of the present invention in detail with reference to the drawings.

In the present disclosure, the terms such as “first”, “second”, and “third” are used merely as labels and are not intended to impose ordinal requirements on the items to which these terms refer.

### First Embodiment

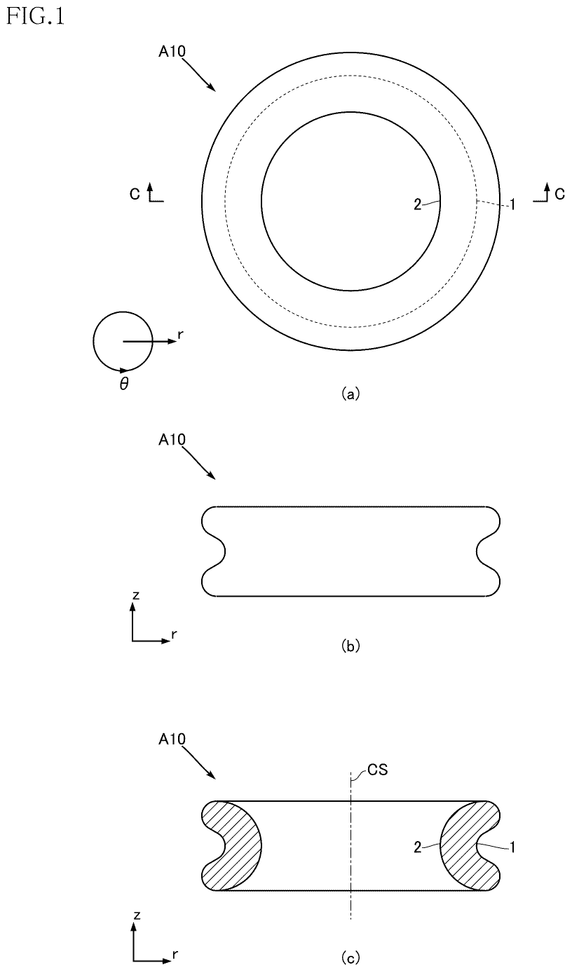

FIGS. 1 to 3 show a sealing material and a sealing structure according to a first embodiment of the present invention. The overall shape of the sealing material of the present invention is not limited, and can be various shapes, such as closed rings without ends, such as circular, elliptical, or rectangular rings, or straight, curved, or bent shapes with ends. The sealing material A10 of present embodiment has the shape of a closed ring, and more specifically, a circular ring with a central axis CS. For the sealing material A10, the radial direction r corresponds to the first direction of the present invention, while the axial direction z corresponds to the second direction of the present invention. The sealing material A10 has the cross-sectional shape shown in FIG. 1(c) in section orthogonal to the circumferential direction θ.

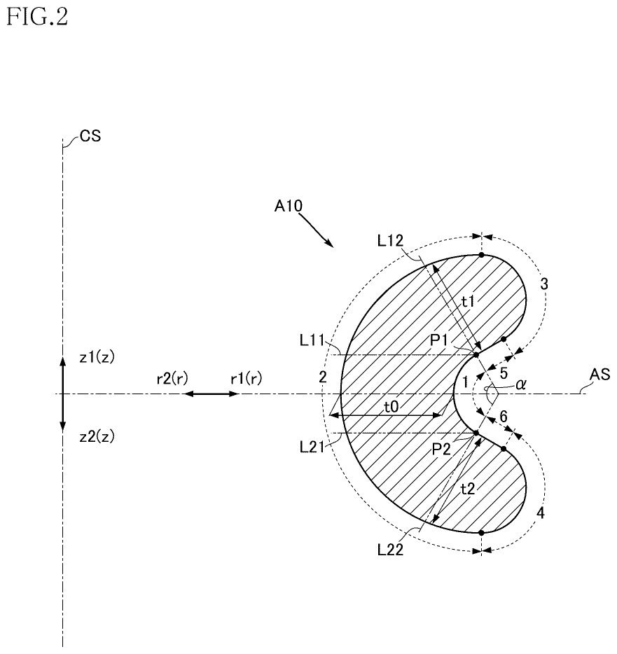

In FIG. 2, the outer side in the radial direction r (the first direction), i.e., the outer side of the ring shape is defined as the r1 side (the first side in the first direction of the present invention), whereas the inner side in the radial direction r (the first direction), i.e., the inner side of the ring shape is defined as the r2 side (the second side in the first direction of the present invention). Also, one side (the upper side) in the axial direction z (the second direction) is defined as the z1 side (the first side in the second direction of the present invention), whereas the other side (the lower side) in the axial direction z (the second direction) is defined as the z2 side (the second side in the second direction of the present invention). The sealing material of the present invention is configured to form a sealing structure and maintain airtightness when sandwiched by the seal objects from both sides in the second direction.

It is preferable that the sealing material A10 is made of a material capable of properly maintaining airtightness when used for the sealing structure B10. Therefore, for the sealing material A10, a material that is highly flexible and easily deforms elastically is selected, and the examples include rubber materials such as fluoro-rubber and silicone rubber.

The sealing material A10 has a first curved surface 1, a second curved surface 2, a third curved surface 3, a fourth curved surface 4, a fifth surface 5, and a sixth surface 6. The first curved surface 1 is located on the r1 side in the radial direction r and a concave surface recessed toward the r2 side in the radial direction r. The second curved surface 2 is located on the r2 side in the radial direction r and a convex surface bulging toward the r2 side in the radial direction r.

The second curved surface 2 overlaps with the entirety of the first curved surface 1 as viewed in the radial direction r. That is, in the cross-sectional shape shown in FIG. 2, when the first end point P1 is defined as the endpoint of the first curved surface 1 on the z1 side in the axial direction z, the straight line L11 that passes through the first end point P1 and is parallel to the radial direction r intersects the second curved surface 2. Also, when the second end point P2 is defined as the endpoint of the first curved surface 1 on the z2 side in the axial direction z, the straight line L21 that passes through the second end point P2 and is parallel to the radial direction r intersects the second curved surface 2.

In the cross-sectional shape shown in FIG. 2, the first straight line L12, which is an extension of the normal to the first curved surface 1 at the first end point P1, intersects the second curved surface 2. Also, the second straight line L22, which is an extension of the normal to the first curved surface 1 at the second end point P2, intersects the second curved surface 2.

In the present embodiment, in the cross-sectional shape shown in FIG. 2, each of the first curved surface 1 and the second curved surface 2 is axisymmetric with respect to the symmetry axis AS extending in the radial direction r.

The thickness t0 of the sealing material A10 along the symmetry axis AS is equal to or greater than 0.5 times and equal to or less than 3.0 times, preferably equal to or greater than 0.5 times and equal to or less than 2.0 times, and more preferably equal to or greater than 1.0 times and equal to or less than 1.5 times the thickness t1 of the sealing material A10 at the portion along the first straight line L12 or the thickness t2 of the sealing material 10 along the second straight line L22.

The angle a formed between the first straight line L12 and the second straight line L22 is equal to or greater than 60° and equal to or less than 210°, and preferably, equal to or greater than 90° and equal to or less than 180°. In the illustrated example, the angle a is set to about 120°. In the illustrated example, the second curved surface 2 is set such that the first straight line L12 and the second straight line L22 intersect the second curved surface 2 in the case where the angle α is 180°.

The third curved surface 3 is a convex surface located between the first curved surface 1 and the second curved surface 2 on the z1 side in the axial direction z and bulging toward the z1 side in the axial direction z and the r1 side in the radial direction r. The third curved surface 3 may be directly connected to the first curved surface 1 and the second curved surface 2 or other portions may be interposed between them. In the illustrated example, the second curved surface 2 and the third curved surface 3 are directly connected, but the first curved surface 1 and the third curved surface 3 are not directly connected. Unlike the illustrated example, the first curved surface 1 and the third curved surface 3 may be directly connected.

The fourth curved surface 4 is a convex surface located between the first curved surface 1 and the second curved surface 2 on the z2 side in the axial direction z and bulging toward the z2 side in the axial direction z and the r1 side in the radial direction r. The fourth curved surface 4 may be directly connected to the first curved surface 1 and the second curved surface 2 or other portions may be interposed between them. In the illustrated example, the second curved surface 2 and the fourth curved surface 4 are directly connected, but the first curved surface 1 and the fourth curved surface 4 are not directly connected. Unlike the illustrated example, the first curved surface 1 and the fourth curved surface 4 may be directly connected. In the cross-sectional shape shown in FIG. 2, the third curved surface 3 and the fourth curved surface 4 are axisymmetric with respect to the symmetry axis AS.

The fifth surface 5 is interposed between the first curved surface 1 and the third curved surface 3. The specific shape of the fifth surface 5 is not limited. In the illustrated example, the fifth surface 5 is a flat surface inclined with respect to the radial direction r. The sixth surface 6 is interposed between the first curved surface 1 and the fourth curved surface 4. The specific shape of the sixth surface 6 is not limited. In the illustrated example, the sixth surface 6 is a flat surface inclined in the opposite direction from the fifth surface 5 with respect to the radial direction r. In the cross-sectional shape shown in FIG. 2, the fifth surface 5 and the sixth surface 6 are axisymmetric with respect to the symmetry axis AS. That is, in the illustrated example, the entirety of the sealing material A10 is axisymmetric with respect to the symmetry axis AS.

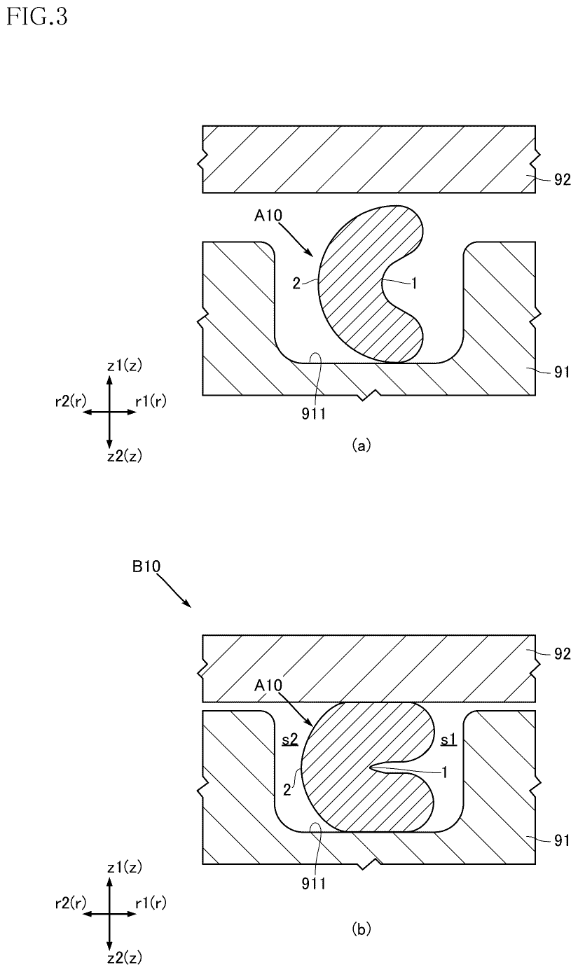

FIG. 3 shows a sealing structure B10 provided by using the sealing material A10. FIG. 3 is a partial sectional view corresponding to FIG. 2, but the central axis CS and the symmetry axis AS are omitted. The sealing structure B10 includes the sealing material A10 and seal objects 91 and 92. The seal objects 91 and 92 are the objects to which airtightness is imparted by the sealing material A10. The shape, size, material or the like of the seal objects 91 and 92 are not limited. In the illustrated example, the seal object 91 has a groove 911. The groove 911 is recessed toward the z2 side in the axial direction z and has the shape of a circular ring as viewed in the axial direction z. The seal object 92 is a plate-like member disposed on the z1 side in the axial direction z with respect to seal object 91.

In FIG. 3(a), the sealing material A10 is placed in the groove 911 of the seal object 91. At this time, the sealing material A10 is still in an uncompressed state, with part of it protruding from the groove 911 toward the z1 side in the axial direction z.

In FIG. 3(b), the seal object 92 is pressed toward the z2 side in the axial direction z, and the sealing material A10 is sandwiched between the seal object 91 and the seal object 92 from both sides in the axial direction z. As a result, the sealing material A10 is compressed in the axial direction 2 and elastically deformed to be bent entirely. That is, the radius of curvature of each of the first curved surface 1 and the second curved surface 2 in the state shown in FIG. 3(b) has become smaller than that in the state shown in FIG. 3(a). In the sealing structure B10 shown in FIG. (b), reaction force in the axial direction z is exerted on each of the seal object 91 and the seal object 92 by the sealing material A10.

In the sealing structure B10, the first region s1 on the r1 side in the radial direction r and the second region s2 on the r2 side in the radial direction r are hermetically separated from each other by sealing material A10. In one embodiment of the sealing structure B10, the first region s1 may correspond to a high-pressure side, while the second region s2 may correspond to a low-pressure side. In another embodiment of the sealing structure B10, the first region s1 may correspond to a low-pressure side, while the second region s2 may correspond to a high-pressure side. In the configuration shown in FIG. 3(b), it may be preferable that the first region s1 corresponds to the high-pressure side, while the second region s2 corresponds to the low-pressure side for preventing unintentional local deformation at an end of the sealing material A10 due to the pressure difference and the resulting weakened airtightness of the sealing structure B10. The first region s1 and the second region s2 may be set to the same pressure. In the case where the first region s1 and the second region s2 are at the same pressure as well, different kinds of fluids in the first region s1 and the second region s2, if they exist, can be prevented from mixing together.

Next, the effects of the sealing material A10 and the sealing structure B10 will be described.

According to the present embodiment, the sealing material A10 has the first curved surface 1 and the second curved surface 2. The second curved surface 2 overlaps with the entirety of the first curved surface 1 as viewed in the radial direction r (the first direction). Such a configuration can reduce the reaction force generated when the sealing material is sandwiched from both sides in the axial direction z (the second direction) as compared with a typical sealing material having a circular cross-sectional shape or a sealing material that includes a flat surface, a bend, a step or the like at the portions corresponding to the first curved surface 1 and the second curved surface 2.

Because the reaction force of the sealing material A10 can be reduced, when the seal object 92 is made of a brittle material such as quartz in, for example, the sealing structure B1 of FIG. 3, the breakage of the seal object 92 due to the reaction force of the sealing material A10 can be suppressed. Also, when the seal object 91 and the seal object 92 slid against each other, small reaction force of the sealing material A10 can suppress the wear of the sealing material A10 due to friction with the seal object 91 and the seal object 92. This prevents the sealing material A10 from being affected by wear particles as impurities.

The second curved surface 2 of the present embodiment is set such that the first straight line L12 and the second straight line L22 intersect the second curved surface 2. With such a configuration, when the sealing material is sandwiched from both sides in the axial direction z, a larger part of the sealing material A10 can be bent and deformed without local imbalance. This is favorable for the reduction of reaction force.

Each of the first curved surface 1 and the second curved surface 2 is axisymmetric with respect to the symmetry axis AS. With such a configuration, when the sealing material A10 is sandwiched from both sides in the axial direction z, the sealing material A10 can be elastically deformed in a more balanced manner. This is advantageous for reducing the reaction force. Also, the entirety of the sealing material A10 is axisymmetric with respect to the symmetry axis AS. Therefore, when the sealing material A10 is to be placed in the groove 911 of the seal object 91 in the sealing structure B10 shown in FIG. 3, the sealing material can be placed in either orientation in the axial direction z. Therefore, forming the sealing structure B10 with an incorrect attaching orientation can be avoided.

Unlike the present embodiment, if a sealing material having the first curved surface 1 on the r2 side and the second curved surface 2 on the r1 side in the radial direction r is formed using a mold, it is difficult to remove the mold located on the r2 side (the inner side) in the radial direction r from the first curved surface 1, which is a concave surface, after the formation. Specifically, for example, it may be necessary to remove a large number of separate molds through a complicated process or to stretch the formed sealing material in the radial direction r and the circumferential direction θ. In such cases, the formation efficiency may decrease or the sealing material may be unintentionally deformed. In the present embodiment, however, the first curved surface 1 is located on the r1 side in the radial direction r while the second curved surface 2 is located on the r2 side in the radial direction r. The sealing material A10 having such a configuration can be formed efficiently by using two molds that can move closer or away toward the z1 side or the z2 side in the axial direction z and molds that can move closer or away toward the r1 side or the r2 side in the radial direction r without the need for stretching the sealing material A10 or other complicated processes.

In the sealing material A10, the thickness to is equal to or greater than 0.5 times and equal to or less than 3.0 times the thickness t1 or the thickness t2. For example, if the thickness to is excessively large relative to the thickness t1 or the thickness t2 and the thickness t1 or the thickness t2 is excessively small relative to the thickness t0, only the two sides in the axial direction z of the sealing material A10 may be selectively deformed, while the central part of the sealing material A10 in the axial direction z may not be deformed to the intended degree. In such a case, the reaction force may not be sufficiently reduced, or airtightness may not be maintained if the pressure difference between the first region s1 and the second region s2 shown in FIG. 3 is large. According to present embodiment, a wider portion of the sealing material A10 can be deformed entirely. This makes it possible to reliably maintain airtightness when the pressure difference between the first region s1 and the second region s2 is large. Also, the sealing material A10 can appropriately maintain airtightness in both cases where the first region s1 is on the high-pressure side and the second region s2 is on the high-pressure side.

When the angle α is equal to or greater than 60° and equal to or less than 210°, the ratio of the first curved surface 1 and the second curved surface 2 to the entire sealing material A10 can be made sufficiently large. This is favorable for the reduction of reaction force.

The sealing material A10 includes the third curved surface 3 and the fourth curved surface 4. The first curved surface 1, the second curved surface 2, the third curved surface 3, the fourth curved surface 4, the fifth surface 5, and the sixth surface 6 are smoothly connected to each other without protruding portions, locally recessed portions, or steps between them. As a result, the entirety of the sealing material A10 has a smooth shape. Thus, it is possible to avoid unintentional stress locally exerting on a certain location when the sealing material is sandwiched from both sides in the axial direction z. This is effective for the reduction of reaction force. Moreover, by suppressing local stress, prevention of selective damage to a portion of the sealing material A10 is expected.

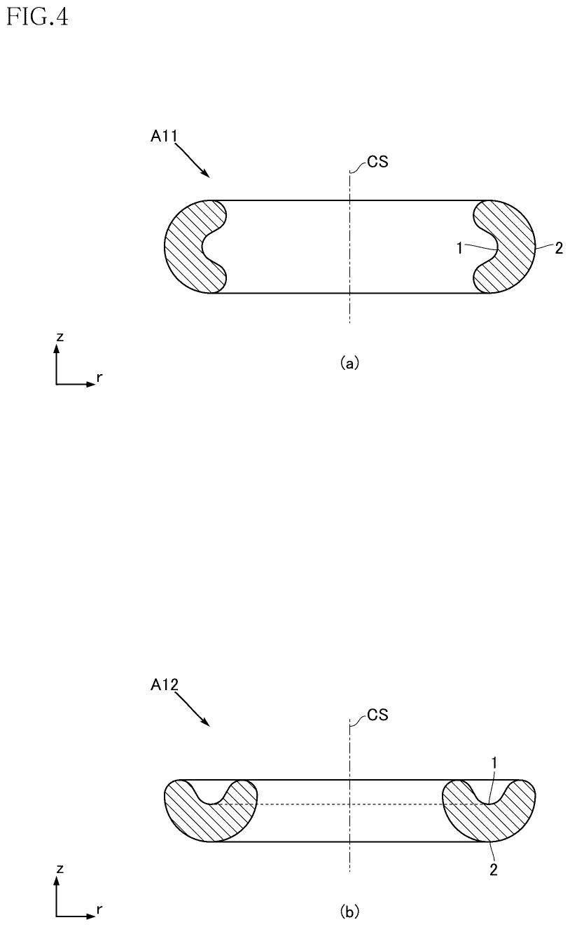

FIGS. 4 to 8 show variations and other embodiments of the present invention. In these figures, the elements that are identical or similar to those of the above-described embodiment are denoted by the same reference signs as those used for the above-described embodiment. Various parts of variations and embodiments may be selectively used in any appropriate combination as long as it is technically compatible.

### First Embodiment, First Variation

FIG. 4(a) shows a first variation of the sealing material A10. In the sealing material A11 of the present variation, the inner side in the radial direction r (the first direction) corresponds to the first side in the first direction of the present invention, and the outer side in the radial direction r (the first direction) corresponds to the second side in the first direction of the present invention. That is, the first curved surface 1 is disposed on the inner side in the radial direction r, while the second curved surface 2 is disposed on the outer side in the radial direction r. The sealing material A11 is also configured to form a sealing structure and maintain airtightness when sandwiched by seal objects from both sides in the axial direction z.

The present variation can also maintain airtightness while reducing the reaction force in attachment. In this way, when the entirety has the shape of a closed ring, the position of each of the first curved surface 1 and the second curved surface 2 may be either on the inner side or the outer side in the radial direction r.

### First Embodiment, Second Variation

FIG. 4(b) shows a second variation of the sealing material A10. For the sealing material A12 of the present variation, the axial direction z corresponds to the first direction of the present invention. The first curved surface 1 is located on one side (the z1 side in FIG. 2) in the axial direction z, while the second curved surface 2 is located on the other side (the z2 side in FIG. 2) in the axial direction z. The sealing material A12 is configured to form a sealing structure and maintain airtightness when sandwiched by seal objects from both sides in the radial direction r.

The present variation can also maintain airtightness while reducing the reaction force in attachment. As understood from the present variation, when the sealing material has the shape of a closed ring as a whole, the first direction is not limited to the radial direction r. For example, the first direction may be the axial direction z. Such a configuration can also reduce the reaction force acting in the radial direction r when the sealing material A12 is sandwiched from both sides (the inner side and the outer side) in the radial direction r.

### Second Embodiment

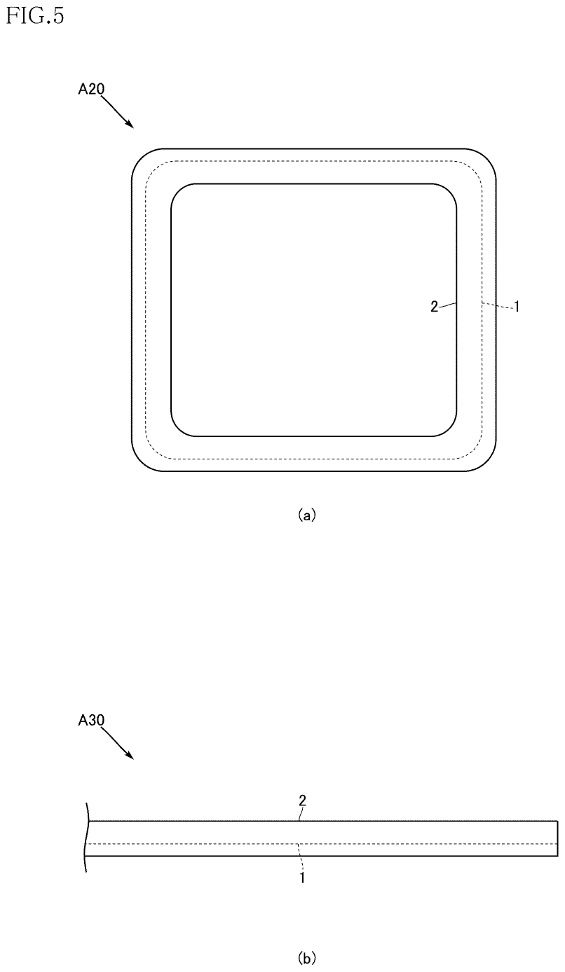

FIG. 5(a) is a plan view showing a sealing material according to a second embodiment of the present invention. The sealing material A20 of the present embodiment has the shape of a rectangular ring as viewed in the axial direction z. The present variation can also maintain airtightness while reducing the reaction force in attachment. As understood from the present embodiment, when the sealing member has the shape of a closed ring as a whole, the specific shape is not limited. The specific shape can be determined according to the shape of the seal objects or other factors, and may be, for example, a circular ring, a rectangular ring, a polygonal ring, or a ring that includes a plurality of bends (protruding outward or inward inward as viewed in the axial direction z).

### Third Embodiment

FIG. 5(b) is a partial plan view showing a sealing material according to a third embodiment of the present invention. The sealing material A30 of the present embodiment is linear as a whole and has ends unlike a circular ring. Other shapes with ends, such as a curved shape or a bent shape, may be employed instead of the linear shape.

The present variation can also maintain airtightness while reducing the reaction force in attachment. As understood from the present embodiment, the sealing material of the present invention is not limited to the shape of a closed ring without ends, and may have a shape with ends. The linear sealing material A30 can also separate two regions located across the sealing material A30 while keeping them in airtight conditions.

### Fourth Embodiment

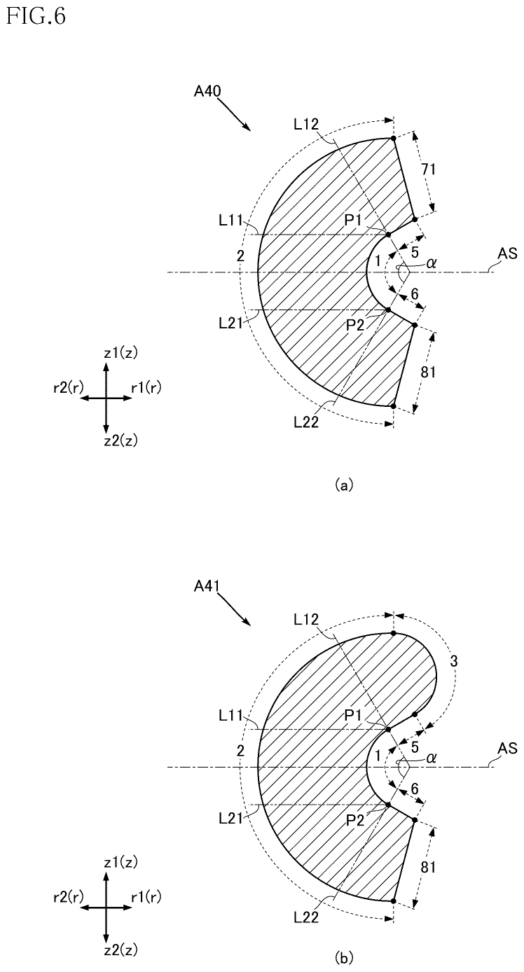

FIG. 6(a) is an enlarged sectional view showing a sealing material according to a fourth embodiment of the present invention and drawn in the same manner as FIG. 2. The sealing material A40 of the present embodiment does not have the third curved surface 3 and the fourth curved surface 4 of the above embodiments, but has a plane surface 71 and a plane surface 81.

The plane surface 71 is interposed between the second curved surface 2 and the first curved surface 1 on the z1 side in the axial direction z and connected to the second curved surface 2 and the fifth surface 5. The plane surface 71 is a flat surface slightly inclined with respect to the axial direction z. The plane surface 81 is interposed between the second curved surface 2 and the first curved surface 1 on the z2 side in the axial direction z and connected to the second curved surface 2 and the sixth surface 6. The plane surface 81 is a flat surface slightly inclined to the opposite side from the plane surface 71 with respect to the axial direction z. The plane surface 71 and the plane surface 81 are axisymmetric with respect to the symmetry axis AS.

The present embodiment can also maintain airtightness while reducing the reaction force in attachment. As understood from the present embodiment, the sealing material of the present invention is not limited to the configuration that includes the third curved surface 3 and the fourth curved surface 4 of the sealing material A10 or the like. The reaction force can be reduced as long as the configuration includes the first curved surface 1 and the second curved surface 2.

### Fourth Embodiment, First Variation

FIG. 6(b) shows a first variation of the sealing material A40. The sealing material A41 of the present variation has the third curved surface 3 and the plane surface 81. That is, the sealing material does not have the fourth curved surface 4 that is axisymmetric with the third curved surface 3 with respect to the symmetry axis AS and the plane surface 71 that is axisymmetric with the plane surface 81 with respect to the symmetry axis AS. Thus, the sealing material A41 as a whole is not axisymmetric with respect to the symmetry axis AS.

The present variation can also maintain airtightness while reducing the reaction force in attachment. As understood from the present variation, the sealing material of the present invention is not limited to a configuration that is axisymmetric with respect to the symmetry axis AS. A configuration that is axisymmetric with respect to the symmetry axis AS or a configuration that is not axisymmetric with respect to the symmetry axis AS may be selected as appropriate depending on the specific shape of the seal objects or other factors.

### Fourth Embodiment, Second and Third Variations

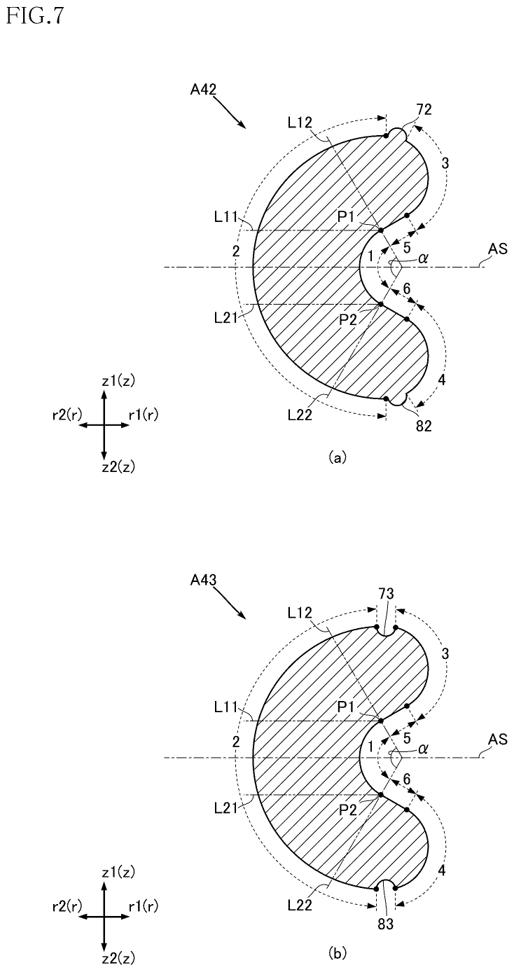

FIG. 7(a) and FIG. 7(b) show a second variation and a third variation, respectively, of the sealing material A40.

The sealing material A42 of the second variation shown in FIG. 7(a) has a protrusion 72 and a protrusion 82. The protrusion 72 is provided between the second curved surface 2 and the third curved surface 3 and protrudes toward the z1 side in the axial direction z. The protrusion 82 is provided between the second curved surface 2 and the fourth curved surface 4 and protrudes toward the z2 side in the axial direction z.

The sealing material A43 of the third variation shown in FIG. 7(b) has a recess 73 and a recess 83. The recess 73 is provided between the second curved surface 2 and the third curved surface 3 and recessed toward the z2 side in the axial direction z. The recess 83 is provided between the second curved surface 2 and the fourth curved surface 4 and recessed toward the z1 side in the axial direction z.

The purpose of providing the protrusions 72 and 82 or the recesses 73 and 83 is not limited, and these may be provided, for example, to achieve a desired contact state with the seal objects 91 and 92 shown in FIG. 3.

These variations can also maintain airtightness while reducing the reaction force in attachment. As understood from these variations, the sealing material of the present invention may be formed with a protrusion or a recess at a portion other than the first curved surface 1 and the second curved surface 2.

### Fifth Embodiment

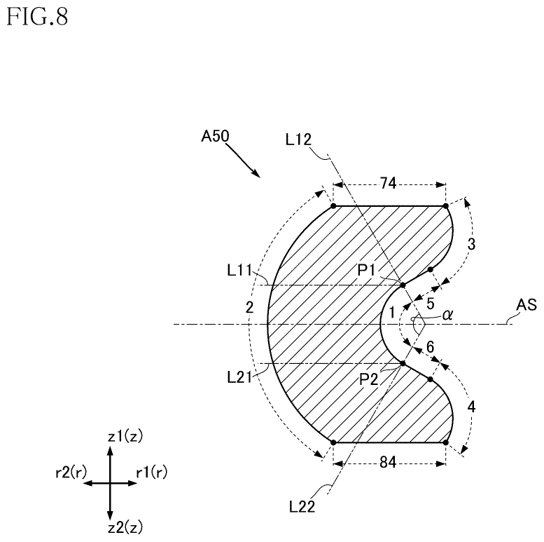

FIG. 8 shows a sealing material according to a fifth embodiment of the present invention. The sealing material A50 of the present embodiment has a plane surface 74 and a plane surface 84. The plane surface 74 is interposed between the second curved surface 2 and the third curved surface 3, and connected to the second curved surface 2 and the third curved surface 3 in the illustrated example. The plane surface 74 is a flat surface generally parallel to the radial direction r. The plane surface 84 is interposed between the second curved surface 2 and the fourth curved surface 4, and connected to the second curved surface 2 and the fourth curved surface 4 in the illustrated example. The plane surface 84 is a flat surface generally parallel to the radial direction r.

In the present embodiment, the first straight line L12 and the second straight line L22 do not intersect the second curved surface 2. That is, the second curved surface 2 of the present embodiment extends over a smaller range (through a smaller angle) as compared with, for example, the second curved surface 2 of the sealing material A10. In the present embodiment again, however, the second curved surface 2 overlaps with the entirety of the first curved surface 1 as viewed in the radial direction r, which is the first direction.

The present embodiment can also maintain airtightness while reducing the reaction force in attachment. From the viewpoint of reducing the reaction force, it is preferable that the second curved surface 2 intersects the first straight line L12 and the second straight line L22, but the present invention is not limited to such a configuration. Maintained airtightness and reduced reaction force in attachment can be expected when the second curved surface 2 overlaps with the entirety of the first curved surface 1 as viewed in the axial direction z.

The sealing material and the sealing structure according to the present invention are not limited to the above-described embodiments. Various modifications in design may be made freely in the specific structure of each part of the sealing material and the sealing structure according to the present invention.

### REFERENCE NUMERALS

A10, A11, A12, A20, A30, A40, A41, A42, A43, A50: Sealing material
B10: Sealing structure
1: First curved surface
2: Second curved surface
3: Third curved surface
4: Fourth curved surface
5: Fifth surface
6: Sixth surface
71, 74, 81, 84: Plane surface
72, 82: Protrusion
73, 83: Recess
91, 92: Seal object
911: Groove
AS: Symmetry axis
CS: Central axis
L12: First straight line
L22: Second straight line
P1: First end point
P2: Second end point
s1: First region
s2: Second region
t0, t1, t2: Thickness
z: Axial direction
r: Radial direction
θ: Circumferential direction
α: Angle

1. A sealing material comprising:
a first curved surface that is located on a first side in a first direction and concave toward a second side opposite from the first side; and
a second curved surface located on the second side in the first direction and convex toward the second side,
wherein the second curved surface overlaps with an entirety of the first curved surface as viewed in the first direction.

2. The sealing material according to claim 1, wherein the first curved surface includes a first end point that is an end on a first side in a second direction orthogonal to the first direction and a second end point that is an end on a second side opposite from the first side in the second direction, and
both a first straight line that is an extension of a normal to the first curved surface at the first end point and a second straight line that is an extension of a normal to the first curved surface at the second end point intersect the second curved surface.

3. The sealing material according to claim 2, wherein the first curved surface and the second curved surface are each axisymmetric with respect to a same symmetry axis extending in the first direction.

4. The sealing material according to claim 3, wherein a thickness of a portion along the symmetry axis is equal to or greater than 0.5 times and equal to or less than 3.0 times a thickness of a portion along the first straight line or the second straight line.

5. The sealing material according to claim 2, wherein an angle formed between the first straight line and the second straight line is equal to or greater than 60° and equal to or less than 210°.

6. The sealing material according to claim 1, further comprising:
a third curved surface interposed between the first curved surface and the second curved surface on the first side in a second direction orthogonal to the first direction; and
a fourth curved surface interposed between the first curved surface and the second curved surface on the second side in the second direction.

7. The sealing material according to claim 1, wherein the sealing material has a shape of a closed ring.

8. The sealing material according to claim 7, wherein the first side in the first direction is an outer side of the ring shape, and
the second side in the first direction is an inner side of the ring shape.

9. A sealing structure comprising:
the sealing material as set forth in claim 1; and
a seal object sandwiching the sealing material from both sides in a second direction orthogonal to the first direction.
